(19) United States
(12) Patent Application Publication
(10) Pub. No.: US 2011/0070406 A1
(43) Pub. Date: Mar. 24, 2011

(54) ADHESIVE BONDING ASSEMBLY FOR LIQUID CRYSTAL DISPLAY

(75) Inventor: YEN-CHANG YAO, Miao-Li County (TW)

(73) Assignee: CHIMEI INNOLUX CORPORATION, Miao-Li County (TW)

(21) Appl. No.: 12/764,098

(22) Filed: Apr. 21, 2010

(30) Foreign Application Priority Data
Sep. 22, 2009 (CN) 200910307442.X

(51) Int. Cl. B32B 3/00; B32B 15/04; B32B 15/082

(52) U.S. Cl. 428/172; 428/457

(57) ABSTRACT

An adhesive bonding assembly of a liquid crystal display includes at least one bonding layer coated on a surface of a first member or a second member, or both, and an adhesive tape arranged between the first member and the second member. The at least one bonding layer of the adhesive bonding assembly comprising an electroplated metal layer. The adhesive bonding assembly may include also at least one adhesive layer including a micro-structural layer. The adhesive tape adhering to the at least one adhesive layer or the bonding layer to connect the first and second members.

### BACKGROUND

1. Technical Field

The present disclosure generally relates to liquid crystal displays, and particularly, to an adhesive bonding assembly used in a liquid crystal display.

2. Description of Related Art

Referring to FIGS. 5 and 6, a liquid crystal display 10 includes a liquid crystal module 11, a backlight module 12, and a carrier 13. The liquid crystal module 11 includes an upper substrate 111, a lower substrate 112, a plurality of driver chips 113 arranged on one side of the lower substrate 112, and a flexible printed circuit board 114. The carrier 13 includes a frame 131 encircling around and accommodating the liquid crystal module 11 and the backlight module 12, an outer frame 132 enclosing the liquid crystal module 11 and the backlight module 12, and a reflecting sheet 133 connected to the frame 131 and arranged under the backlight module 12. The flexible printed circuit board 114 can be bent to adhere to the bottom of the frame 131. Any two of the flexible printed circuit board 114, the lower substrate 112, and the frame 131, or any other members, are connected together by an adhesive tape 20.

However, as liquid crystal displays are designed with increasing reduction in thickness, the contact area of the elements described above becomes smaller correspondingly, thus a thinner adhesive tape must be chosen for usage. As a result, the bonding strength reduces accordingly, and the adhesive tape may be dislodged by the restoring elastic force of the bent flexible printed circuit board 114, resulting in detachment of the elements from each other.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a cross-section of a first embodiment of an adhesive bonding assembly of a liquid crystal display.

FIG. 2 is a plan view of a second embodiment of an adhesive bonding assembly of a liquid crystal display.

FIG. 3 is a plan view of a plurality of micro-structures of the adhesive bonding assembly of FIG. 2.

FIG. 4 is a partial cross-section of the adhesive bonding assembly of FIG. 2.

FIG. 5 is a partially exploded, isometric view of a commonly used liquid crystal display.

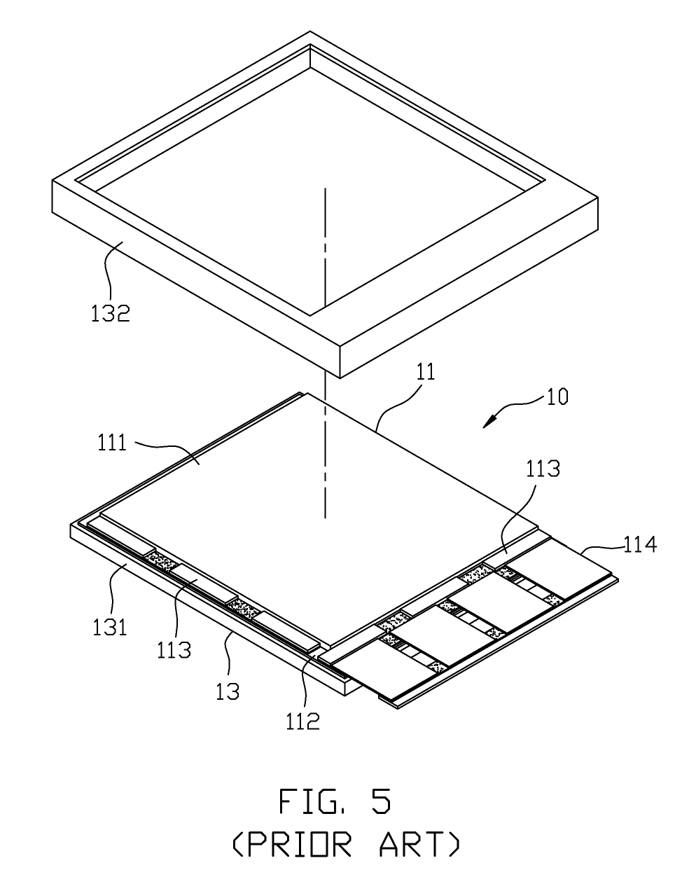

FIG. 6 is a cross-section of the liquid crystal display of FIG. 5

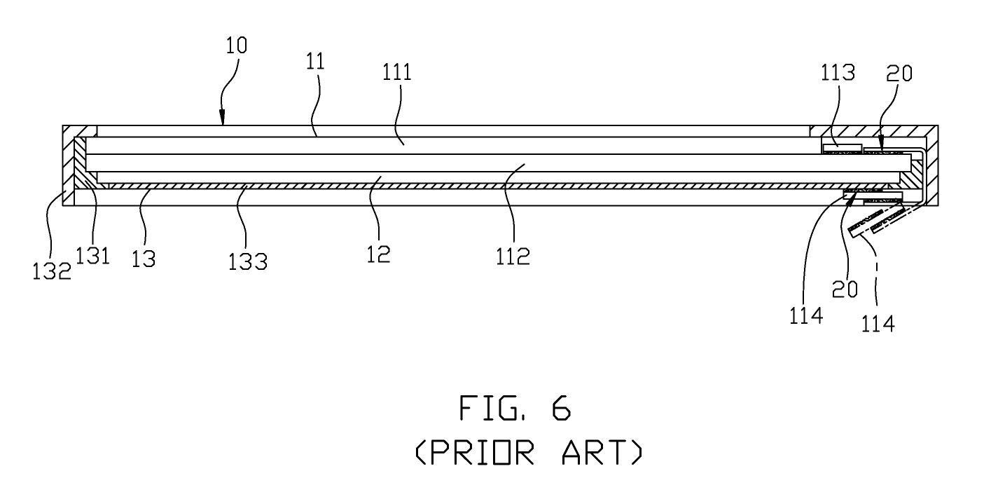

### DETAILED DESCRIPTION

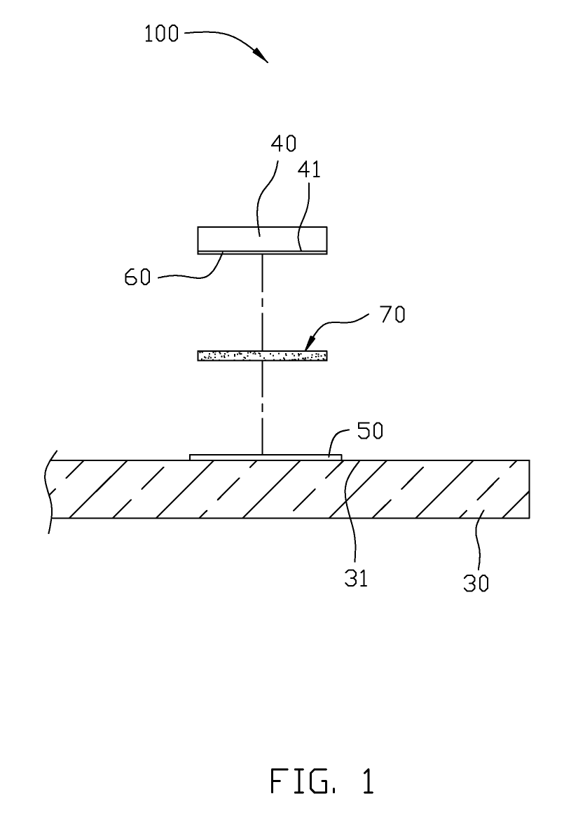

Referring to FIG. 1, a first embodiment of an adhesive bonding assembly 100 used for a liquid crystal display (not shown) includes a first member 30 having a first surface 31, and a second member 40 having a second surface 41 facing the first surface 31, a first bonding layer 50 formed on the first surface 31, a second bonding layer 60 formed on the second surface 41, and an adhesive tape 70 arranged between the first bonding layer 50 and the second bonding layer 60. The first member 30 and the second member 40 may be two components used in a backlight module or a liquid crystal module, such as a flexible circuit board and a lower substrate, a frame and a flexible circuit board, or a lower substrate and a frame.

In the illustrated embodiment, the first bonding layer 50 and the second bonding layer 60 are stainless steel metal layers coated on the first surface 31 of the first member 30 and the second surface 41 of the second member 40 by electroplating. The adhesive tape 70 is an acrylic glue.

Alternatively, the bonding layer may be defined only on the first surface 31 of the first member 30 or the second surface 41 of the second member 40, which can also enhance the adhesion force between the first member 30 and the second member 40.

Adhesive forces between the adhesive tape 70 of 20 mm in length and other member layers are tested under a peel test by using a testing device. The adhesive force between the adhesive tape 70 and an electroplated stainless steel metal layer, such as, the first bonding layer 50 or the second bonding layer 60, is 20 N. Furthermore, the adhesive force between the adhesive tape 70 and an acrylic acid layer is 16 N, and between the adhesive tape 70 and a polyester layer is 15N. Thus, the adhesion force of the electroplated stainless steel metal layer surpasses that of the acrylic layer and the polyester layer when bonding with the adhesive tape 70.

The adhesive tape 70 may have an improved adhesion force when bonded with a different material, which enhances the bonding strength of the bonding structure between the first member 30 and the second member 40, whereby the first member 30 and the second member 40 are prevented from detaching from each other.

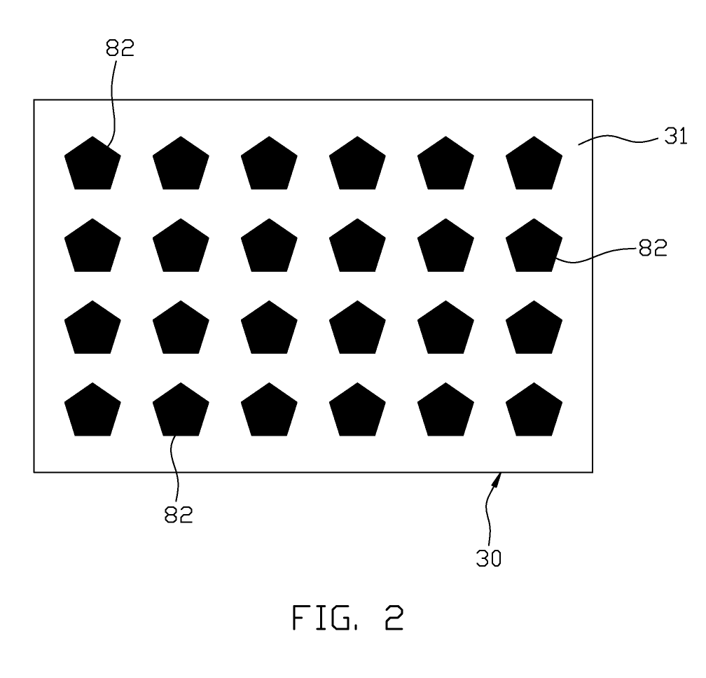

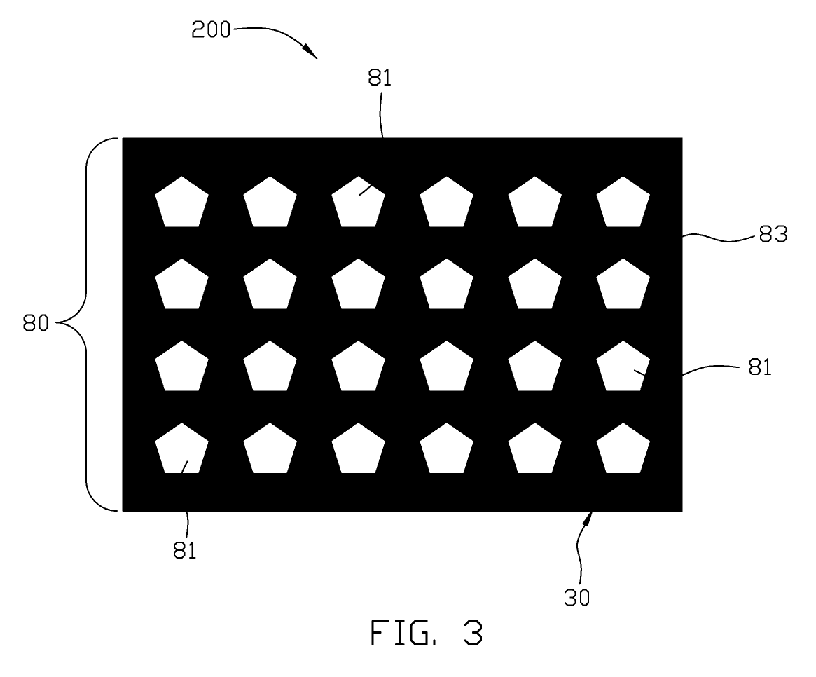

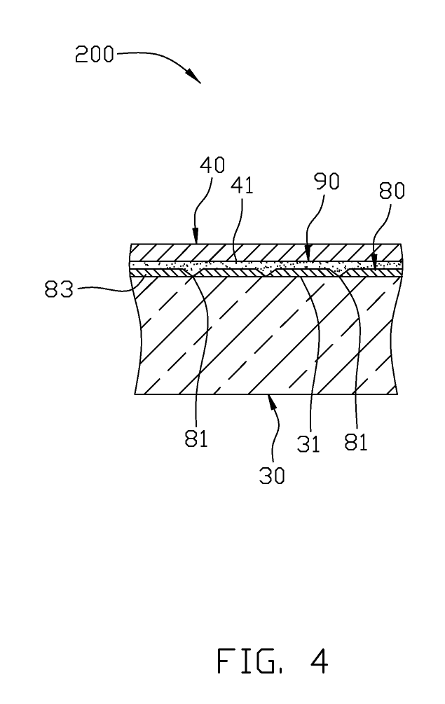

FIGS. 2 through 4 show a second embodiment of an adhesive bonding assembly 200 bonding the first member 30 and the second member 40, the adhesive bonding assembly 200 further including an adhesive layer 80 coated on the first surface 31 of the first member 30 and an adhesive tape 90 adhered to the adhesive layer 80.

The adhesive layer 80 includes a plurality of micro-structures 81. The micro-structures 81 may be protrusions, recesses, slots, or combinations thereof, and be V-shaped, polygonal, circular, semicircular, mesh points, or any combination of at least two thereof. In the illustrated embodiment, the micro-structures 81 are pentagonal slots and formed as follows. The first member 30 includes an adhesive area (not labeled) in the first surface 31, a plurality of printing ink points 82 is coated inside the adhesive area, and an electroplated metal layer 83 is coated on the remaining portion of the adhesive area, then the printing ink points 82 are removed to form the micro-structures 81.

The micro-structures 81 can receive the adhesive material of the adhesive tape 90, thus, the contact area between the first member 30 and the adhesive tape 90 is thereby increased. Therefore, the bonding force of the micro-structures 81 is increased, and the adhesion force between the first member 30 and the second member 40 is enhanced.

The adhesive tape 70 of the first embodiment is bonded with a metal layer, and the adhesive tape 90 of the second embodiment is bonded with a layer including a plurality of micro-structures 81, which can both increase the adhesive force between the first member 30 and the second member 40. When a liquid crystal display provides an extremely thin profile, the adhesives tapes 70, 90 provide sufficient adhesive forces to prevent the first member 30 and the second member 40 from detachment, thus enhancing the quality and strength of the liquid crystal display.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. An adhesive bonding assembly used in a liquid crystal display, comprising:
a first member comprising a first surface;
a second member comprising a second surface facing the first surface of the first member;
at least one bonding layer coated on at least one of the first surface of the first member and the second surface of the second member, wherein the at least one bonding layer is a metal layer; and
an adhesive tape arranged between the first member and the second member, adhering to the at least one bonding layer to bond the first and second members.

2. The adhesive bonding assembly of claim 1, wherein the at least one bonding layer is a metal layer.

3. The adhesive bonding assembly of claim 2, wherein the metal layer is coated on the surface of the at least one of the first surface of the first member and the second surface of the second member by electroplating.

4. The adhesive bonding assembly of claim 3, wherein the metal layer comprises stainless steel.

5. The adhesive bonding assembly of claim 1, comprising two bonding layers, wherein one bonding layer is coated on the first surface of the first member and the other bonding layer is coated on the second surface of the second member.

6. The adhesive bonding assembly of claim 1, comprising one bonding layer coated on the first surface of the first member.

7. The adhesive bonding assembly of claim 1, wherein the adhesive tape comprises an acrylic glue.

8. An adhesive bonding assembly of a liquid crystal display, comprising:
a first member comprising a first surface;
a second member comprising a second surface facing the first surface of the first member;
at least one adhesive layer comprising a plurality of micro-structures coated on at least one of the first surface of the first member and the second surface of the second member, and
an adhesive tape arranged between the first member and the second member, wherein the adhesive tape is adhered to the at least one adhesive layer to bond the first and second members.

9. The adhesive bonding assembly of claim 8, wherein the at least one adhesive layer comprising an electroplated metal layer.

10. The adhesive bonding assembly of claim 9, wherein the first member comprising an adhesive area on one surface thereof; the adhesive layer comprises a plurality of printing ink points coated on parts of the adhesive area of the first member, an electroplated metal layer formed on the remaining portion of the adhesive area, and the printing ink points removed to form the micro-structures.

11. The adhesive bonding assembly of claim 10, wherein the micro-structures are protrusions, recesses, slots, or combination thereof.

12. The adhesive bonding assembly of claim 11, wherein the micro-structures are V-shaped, polygonal, circular, semicircular, mesh points, or any combination of at least two thereof.

13. The adhesive bonding assembly of claim 12, wherein the micro-structures are pentagonal slots.

14. The adhesive bonding assembly of claim 8, comprising two bonding layers, one bonding layer coated on the first surface of the first member, the other bonding layer coated on the second surface of the second member.

15. The adhesive bonding assembly of claim 8, comprising one bonding layer coated on the first surface of the first member.

16. The adhesive bonding assembly of claim 8, wherein the adhesive tape comprises an acrylic glue.
